(19) United States
(12) Patent Application Publication
(10) Pub. No.: US 2012/0325883 A1
(43) Pub. Date: Dec. 27, 2012

(54) CONNECTING ROD FRACTURE SPLITTING METHOD AND APPARATUS THEREFOR

(75) Inventors: Tatsushi KAIHO, Shizuoka-Ken (JP); Shigenori YAMADA, Shizuoka-Ken (JP); Osahiko HORII, Shizuoka-Ken (JP); Toshiyuki MATSUNO, Shizuoka-Ken (JP); Satoru KOBAYASHI, Shizuoka-Ken (JP)

(73) Assignee: SUZUKI MOTOR CORPORATION, Shizuoka-Ken (JP)

(21) Appl. No.: 13/530,195

(22) Filed: Jun. 22, 2012

(30) Foreign Application Priority Data
Jun. 24, 2011 (JP) 2011-140759

(51) Int. Cl. B26F 3/00

(52) U.S. Cl. 225/1; 225/100

(57) ABSTRACT

The connecting rod as a vehicle engine component is manufactured by a connecting rod fracture splitting method. The connecting rod is provided with a large end portion, a small end portion and a rod portion connecting the large and small end portions, the large end portion being provided with a connecting rod body and a cap which are split from each other along a fracture-split surface formed thereto. The connecting rod is subjected to fracture splitting by inserting a large end-side shaft into a through hole formed in the large end portion, fixing the large end-side shaft to a large end-side support, inserting a small end-side shaft into a through hole formed in the small end portion, fixing the small end-side shaft to a small end-side support, and pulling at least one of the large end-side support and small end-side support away from another one of both the supports.

### BACKGROUND OF THE INVENTION

1. Field of the Invention

The present invention relates to a connecting rod fracture splitting method and an apparatus therefor, particularly for a connecting rod of a component or parts of an engine of a vehicle such as an automobile.

2. Description of the Related Art

Generally, as illustrated in FIG. 3, a connecting rod 1 is generally used for connecting a crank pin and a piston pin in an engine of a vehicle such as automobile engine.

The connecting rod 1 has one end having a large end portion 2 and another one end having a small end portion 3. The large end portion 2 is a portion to be attached to the crank pin, and the small end portion 3 is a portion to be attached to the piston pin. The connecting rod 1 is composed of a connecting rod body 4 and a cap 5 so as to be attached to the crank pin. The large end portion 2 is formed with bolt holes at both opposite end sides in a width direction thereof, and bolts are respectively inserted into the bolt holes to fasten the connecting rod body 4 and the cap 5 together.

In a general method of manufacturing a connecting rod 1 of the above structure, there has been proposed a so-called fracture splitting method of splitting an integrally-formed connecting rod into the connecting rod body 4 and the cap 5 by fracture, for example, as disclosed in Patent Document 1 (Japanese Patent Laid-Open Publication No. 2000-71130) or Patent Document 2 (Japanese Patent Laid-Open Publication No. 2002-66998)).

In a conventional connecting rod fracture splitting method, as shown in FIG. 3, notches 7 are first respectively formed on widthwise opposite sides of an inner circumferential portion of a large end hole 6 in the large end portion 2. A position of the connecting rod 1 is determined by inserting a shaft into a small end hole 8 in the small end portion 3. A mandrel 9 having a pair of halved portions, which are tapered on one side or both sides, is fitted into the large end hole 6 (FIG. 3A).

At this time, a portion between the halved portions is located at a position corresponding to each of the notches 7. A wedge 10 is then driven between the halved portions of the mandrel 9 to thereby apply an expansive force to the large end portion 2 in a direction of white arrows in FIG. 3A. The connecting rod 1 is thereby split into the connecting rod body 4 and the cap 5 at the notches 7.

In the above conventional connecting rod fracture splitting method, however, if there is a large clearance between the small end hole 8 and the shaft inserted into the small end hole 8, a timing of splitting the connecting rod 1 along a fracture-split surface of the large end portion 2 may differ between right and left sides of the large end portion 2, and in such case, the right and left sides of the large end portion 2 may be thereby fractured at different timings (FIG. 3B). In this case, it has been known through experiences that ductile fracture easily occurs in a fracture surface on the side fractured at a latter timing. Since fracture surfaces with ductile fracture do not fit well together, a roundness (a roundness upon reassembly) of the large end portion 2 of the connecting rod 1 is deteriorated when a crank shaft is attached thereto. In the worst case, seizure may occur to damage an engine.

### SUMMARY OF THE INVENTION

The present invention was conceived in consideration of the circumstances mentioned above and an object thereof is to provide a connecting rod fracture splitting method and apparatus therefor capable of providing a favorable fracture surface with no ductile fracture in a fracture-split surface of a large end portion of a connecting rod by reducing a difference between fracture timings on right and left sides of the large end portion of the connecting rod occurring when a connecting rod is split along the fracture-split surface, and thereby improving a roundness upon reassembly.

The above and other objects can be achieved according to the present invention by providing, in one aspect, a fracture splitting method for splitting a connecting rod into a connecting rod body and a cap formed integrally, the method including the steps of: preparing a connecting rod having a large end portion, a small end portion and a rod portion connecting the large and small end portions, the large end portion having a fracture-split surface along which the connecting rod body and the cap is split, the large end portion having a through hole and the small end portion having a through hole; inserting a large end-side shaft into the through hole formed in the large end portion; fixing the large end-side shaft to a large end-side support; inserting a small end-side shaft into the through hole formed in the small end portion; fixing the small end-side shaft to a small end-side support; and pulling at least either one of the large end-side support and the small end-side support in a direction away from another one of the supports.

In another aspect, there is provided a fracture connecting rod splitting apparatus for splitting a connecting rod into a connecting rod body and a cap formed integrally, the connecting rod having a large end portion, a small end portion and a rod portion connecting the large and small end portions, the large end portion having a fracture-split surface along which the connecting rod body and the cap is split, the large end portion having a through hole and the small end portion having a through hole, the apparatus including: a large end-side shaft inserted into the through hole formed in the large end portion; a large end-side support supporting the large end-side shaft; a small end-side shaft inserted into the through hole formed in the small end portion; a small end-side support supporting the small end-side shaft; and a pulling unit pulling at least either one of the large end-side support and the small end-side support in a direction away from another one of the supports.

The fracture-split surface may be formed to notches formed to the large end portion at portions opposite to each other.

According to the present invention of the characters mentioned above, a favorable fracture surface with no ductile fracture is obtainable in the fracture-split surface of the large end portion of the connecting rod by reducing a difference between fracture timings on right and left sides of the large end portion occurring when the connecting rod is split along the fracture-split surface, for example, notches formed thereto, and a roundness upon reassembly of the connecting rod after splitting can be improved.

The nature and further characteristic features of the present invention will be made clearer from the following descriptions made with reference to the accompanying drawings.

### BRIEF DESCRIPTION OF THE DRAWINGS

In the accompanying drawings:

FIG. 1 is an illustrated plan view explaining a connecting rod fracture splitting method and apparatus therefor according to an embodiment of the present invention;

FIG. 2 is a side view illustrating the connecting rod fracture splitting method and apparatus therefor according to the embodiment of the present invention; and

FIG. 3, including FIGS. 3A and 3B, is an illustrated plan view explaining a conventional connecting rod fracture splitting method.

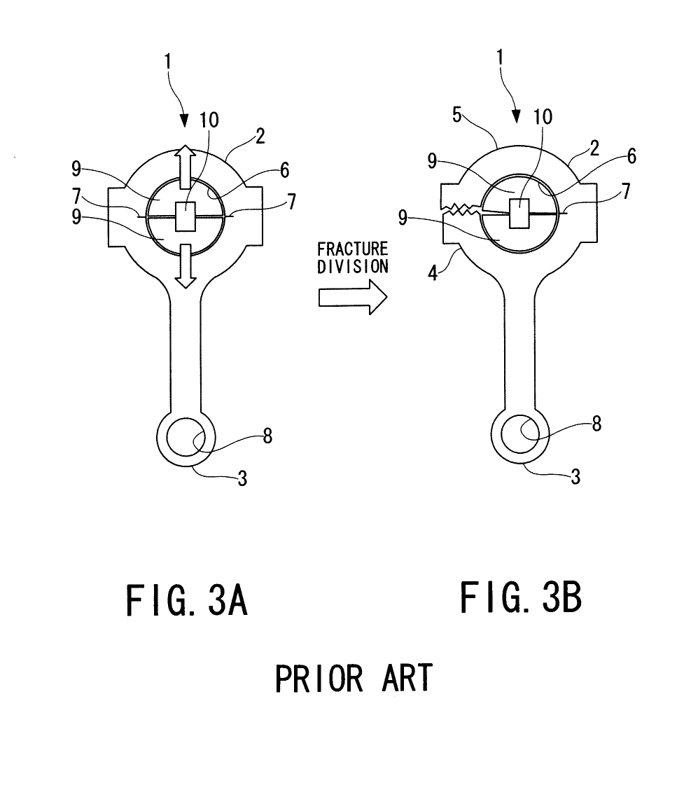

### DESCRIPTION OF THE PREFERRED EMBODIMENT

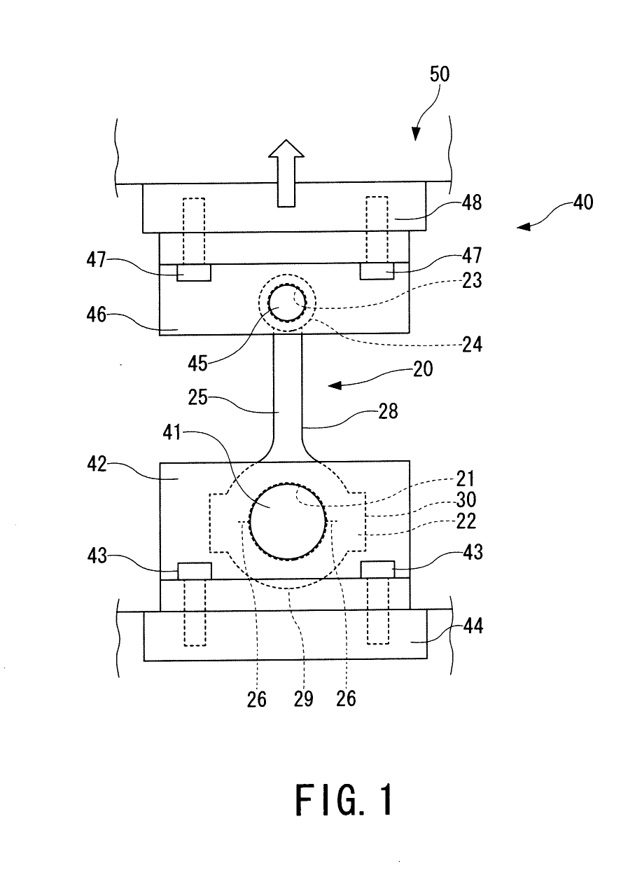

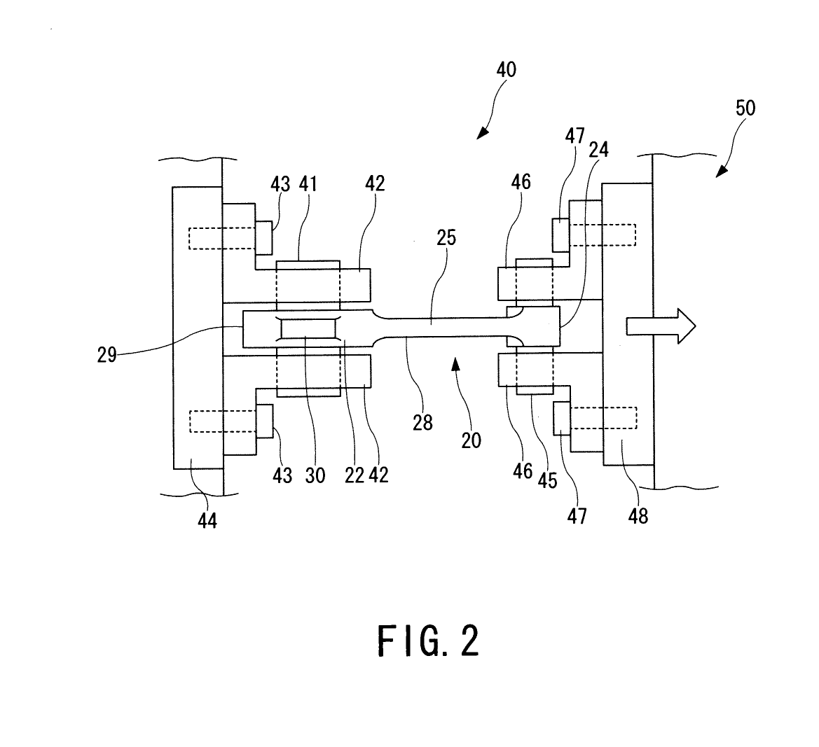

In the following, a connecting rod fracture splitting method and apparatus therefor according to an embodiment of the present invention will be described by reference to the accompanying drawings of FIGS. 1 and 2

In the followings, a case in which the present invention is applied to fracture splitting technology of a connecting rod for use in an automobile engine will be described as one embodiment of the present invention.

First, an entire configuration of a connecting rod split by the fracture splitting method and apparatus according to the embodiment of the present invention will be described. In the followings, it is to be noted that a vertical direction in FIG. 1 is set as a longitudinal direction of the connecting rod, a horizontal direction in FIG. 1 is set as a width direction of the connecting rod, and a direction perpendicular to the plane of paper in FIG. 1 is a thickness direction of the connecting rod.

A connecting rod 20 is composed of a large end portion 22 at one end, a small end portion 24 at another end and a rod portion 25 connecting the large end portion 22 and the small end portion 24.

A large end hole 21 is drilled in the large end portion 22 in the thickness direction of the connecting rod so that a crank pin, not shown, is inserted therethrough. A small end hole 23 is drilled in the small end portion 24 in the thickness direction of the connecting rod so that a piston pin, not shown, is inserted therethrough.

Notches (or notch groves) 26 are provided in the large end portion 22 on widthwise opposite sides of an inner circumferential portion of the large end hole 21. Fracture-split surfaces are formed outward from the notches 26 in the width direction. The connecting rod 20 is split into a connecting rod body 28 and a cap 29 along the fracture-split surfaces of the large end portion 22. The connecting rod body 28 extends in the longitudinal direction and is composed of a lower half portion of the large end portion 22, the small end portion 24, and the rod portion 25 connecting the lower half portion of the large end portion 22 and the small end portion 24.

Flat surfaces 30 are longitudinally formed on an outer circumferential surface of the large end portion 22 at widthwise opposite ends. Bolt holes, not shown, are drilled parallel to the flat surfaces 30 on a widthwise inner side of the flat surfaces 30. Bolts, not shown, are respectively inserted into the bolt holes to fasten the connecting rod body 28 and the cap 29 together.

Next, a fracture splitting apparatus 40 for the connecting rod 20 according to the embodiment of the present invention will be described.

The fracture splitting apparatus 40 is used for splitting the connecting rod 20 into the connecting rod body 28 and the cap 29 along the fracture-split surfaces of the large end portion 22. The fracture splitting apparatus 40 includes a large end-side shaft 41, large end-side fixing members 42 each having an L-shape in side view as shown in FIG. 2, a large end-side support 44, a small end-side shaft 45, small end-side fixing members 46 each having an L-shape in side view also in FIG. 2, a small end-side support 48, and a pulling unit 50. The large end-side shaft 41 is inserted into the large end hole 21 of the large end portion 22. Both end portions of the large end-side shaft 41 are respectively inserted through the large end-side fixing members 42. The large end-side fixing members 42 are respectively fixed to the large end-side support 44 via bolts 43. The small end-side shaft 45 is inserted into the small end hole 23 of the small end portion 24. Both end portions of the small end-side shaft 45 are respectively inserted through the small end-side fixing members 46. The small end-side fixing members 46 are respectively fixed to the small end-side support 48 by means of bolts 47. The pulling unit 50 pulls the small end-side support 48 in a direction away from the large end-side support 44.

Hereunder, a connecting rod fracture splitting method by using the fracture splitting apparatus 40 having the structure mentioned above will be described.

First, the connecting rod body 28 and the cap 29 are integrally formed by forging a steel material (e.g., SC-based direct-heat treated steel). The notches 26 (having fracture split surface) are respectively formed in the large end portion 22 on the widthwise opposite sides of the inner circumferential portion of the large end hole 21.

Subsequently, the large end-side shaft 41 is inserted through the large end hole 21 of the large end portion 22. The both end portions of the large end-side shaft 41 are respectively inserted through and supported by the large end-side fixing members 42. The respective large end-side fixing members 42 are fixed to the large end-side support 44 by means of the bolts 43. The small end-side shaft 45 is also inserted through the small end hole 23 of the small end portion 24. The both end portions of the small end-side shaft 45 are respectively inserted through and supported by the small end-side fixing members 46. The respective small end-side fixing members 46 are fixed to the small end-side support 48 by means of the bolts 47, thus determining the positioning of the connecting rod 1.

Subsequently, the pulling unit pulls 50 the small end-side support 48 in a direction away from the large end-side support 44 (i.e., direction of a large white arrows in FIGS. 1 and 2) without moving the large end-side support 44. The connecting rod 20 is thereby fractured in the width direction at the notches 26 and then split into the connecting rod body 28 and the cap 29 along the fracture-split surfaces of the large end portion 22.

The following Table 1 shows results of experiences obtained by splitting three specimens of the connecting rod 20 into the connecting rod body 28 and the cap 29 by the fracture splitting method according to the embodiment of the present invention in comparison with results obtained by splitting the specimens by a conventional fracture splitting method (a case in which there is a large clearance, of about 260 μm, between the small end hole and the shaft inserted into the small end hole).

As shown in Table 1, “percent ductile fracture” representing a ratio of ductile fracture to an area of a fracture-split surface was 0% in the fracture splitting method according to the embodiment of the present invention. It is thereby evident that a favorable fracture surface with no ductile fracture is obtained by the fracture splitting method according to the embodiment of the present invention.

In addition, it is also found that all of a roundness variation before and after fracture splitting, a roundness after finish treatment, and a roundness upon reassembly have been improved as compared to those obtained by the conventional connecting rod fracture splitting method.

TABLE 1

| | | Roundness | | |
|---|---|---|---|---|
| | | Variation | | |
| | | before and | Roundness | |
| | Percent | after | after | Roundness |
| | Ductile | fracture | finish | Upon |
| | Fracture | splitting | treatment | Reassembly |
| | (%) | (μm) | (μm) | (μm) |
| Conventional | 11 | 96.8 | 3.3 | 14.0 |
| method | | | | |
| Method of | 0 | 10.9 | 3.0 | 5.4 |
| the present | | | | |
| invention | | | | |

In the connecting rod fracture splitting method and the connecting rod fracture splitting apparatus according to the embodiment of the present invention, difference between fracture timings on right and left sides occurring when the connecting rod 20 is split along the fracture-split surfaces of the large end portion 22 can be reduced. Accordingly, a favorable fracture surface with no ductile fracture is obtained in the fracture-split surface, and the roundness upon reassembly is thereby improved.

It is further to be noted that the present invention is not limited to the described embodiment, and many other changes and modifications or alternations may be made without departing from the scopes of the appended claims.

For example, although in the described embodiment of the present invention, the pulling unit 50 pulls the small end-side support 48 in the direction away from the large end-side support 44 without moving the large end-side support 44 when the connecting rod 20 is split into the connecting rod body 28 and the cap 29, at least either one of the large end-side support 44 and the small end-side support 48 may be pulled in a direction away from another of the supports. For example, the large end-side support 44 is pulled in a direction away from the small end-side support 48 without moving the small end-side support 48 in contrast to the embodiment mentioned above, or both the large end-side support 44 and the small end-side support 48 may be pulled in directions away from each other.

Furthermore, although the present invention is applied to the connecting rod fracture splitting technology for use in automobile engines, in another embodiment or modification, the connecting rod fracture splitting technology may be applied to use in engines of motorcycles or the like.

Still furthermore, although in the described embodiment, the connecting rod 20 is formed by forging, the connecting rod 20 may be also formed by sintering, casting, or the like.

What is claimed is:

1. A connecting rod fracture splitting method for splitting a connecting rod into a connecting rod body and a cap formed integrally, the method comprising:
preparing a connecting rod having a large end portion, a small end portion and a rod portion connecting the large and small end portions, the large end portion having a fracture-split surface along which the connecting rod body and the cap is split, the large end portion having a through hole and the small end portion having a through hole;
inserting a large end-side shaft into the through hole formed in the large end portion;
fixing the large end-side shaft to a large end-side support;
inserting a small end-side shaft into the through hole formed in the small end portion;
fixing the small end-side shaft to a small end-side support; and
pulling at least either one of the large end-side support and the small end-side support in a direction away from another one of the supports.

2. The connecting rod fracture splitting method according to claim 1, wherein the fracture-split surface is formed to notches formed to the large end portion at portions opposite to each other.

3. A fracture connecting rod splitting apparatus for splitting a connecting rod into a connecting rod body and a cap formed integrally, the connecting rod having a large end portion, a small end portion and a rod portion connecting the large and small end portions, the large end portion having a fracture-split surface along which the connecting rod body and the cap is split, the large end portion having a through hole and the small end portion having a through hole, the apparatus comprising:
a large end-side shaft inserted into the through hole formed in the large end portion;
a large end-side support supporting the large end-side shaft;
a small end-side shaft inserted into the through hole formed in the small end portion;
a small end-side support supporting the small end-side shaft; and
a pulling unit pulling at least either one of the large end-side support and the small end-side support in a direction away from another one of the supports.

4. The connecting rod fracture splitting apparatus according to claim 3, wherein the fracture-split surface is formed to notches formed to the large end portion at portions opposite to each other.
